(19) United States
(12) Patent Application Publication
(10) Pub. No.: US 2011/0154289 A1
(43) Pub. Date: Jun. 23, 2011

(54) OPTIMIZATION OF AN APPLICATION PROGRAM

(76) Inventors: Sandya Srivilliputtur MANNARSWAMY, Bangalore (IN); Rishi Surendran, Bangalore (IN)

(21) Appl. No.: 12/642,544

(22) Filed: Dec. 18, 2009

(51) Int. Cl. G06F 9/44; G06F 9/45

(52) U.S. Cl. 717/106; 717/110; 717/159

(57) ABSTRACT

Methods for optimizing a region of an application program are described. A delinquent region of the application program is identified based on a data utilization parameter. The delinquent region is optimized by creating an optimized structure type associated with the delinquent region. The optimized structure type includes one or more data fields selected based on delinquent region profile information.

### BACKGROUND

The overall performance of an application program executed on a computing device has become limited by the capabilities of the memory in the computing device. Generally, processors in the computing device operate faster than an associated memory can supply data to them. To bridge this processor-memory gap, high performance memory, such as cache memory, is implemented in computing devices. A cache memory temporarily stores recently and frequently accessed data and instantly provides the data to the processor at high speeds as and when needed. Further, the cache memory, in general, is faster than a main memory of the computing device.

Whenever data is fetched from the cache memory a cache hit is said to occur. Greater the cache hit rate, better is the cache utilization and, consequently, better is the overall performance of an application program executed on the computing device. Thus, cache utilization becomes one of the determinants of the performance of the application program and may also help bridge the processor-memory gap.

Generally, to enhance cache utilization, various optimization techniques have been suggested. One such technique, called structure layout optimization, seeks to enhance cache utilization by transforming the layout of data structures of an application program without affecting an intended output of the application program. Such an optimization technique, however, is generally restricted to type safe languages, such as Java, and has found little application when used with non-type safe languages, such as C and C++. Additionally, even after implementation of such optimization techniques to type safe languages, performance of the application may not be enhanced to its complete potential.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary computing device for optimization of an application program, in accordance with an embodiment of the present invention.

FIG. 2 illustrates exemplary components of a compiling module, in accordance with an embodiment of the present invention.

FIG. 3 illustrates an exemplary method for optimizing an application program, in accordance with an embodiment of the present invention.

FIG. 4 illustrates an exemplary method for optimizing a region of an application program, in accordance with an embodiment of the present invention.

### DETAILED DESCRIPTION

Devices and methods for optimizing an application executed on a computing device are described. The described devices and methods optimize delinquent regions of the application program and transform a layout of one or more data structures associated with the delinquent regions, thereby providing for enhanced application performance. The layout of a data structure may be understood as an organization of data fields, interchangeably referred to as fields, of the data structure in the memory where data is stored. Further, the application performance may be evaluated based on one or more application features, such as execution time, data cache (dcache) miss, and Data Translation Lookaside Buffer (DTLB) miss.

Generally, a computing device uses a compiler for transforming a source code of the application program into an executable object code. The application program may include data, which may further include attributes or fields. Further, the data can be organized into data structures, which may correspond to a wide variety of data items such as program variables and constants, arrays, structures, classes, records, or other aggregate data structures. When a processor of the computing device executes the application program, the data may get stored in a temporary storage media, such as a cache memory. The data is often placed in the cache memory to reduce data access time, thereby enhancing performance of the application.

To optimize memory performance, that is to enhance memory performance, the compiler implements various optimization techniques, such as structure layout optimization. Structure layout optimization enhances memory performance by transforming the layout of the fields of one or more data structures of the application program executing on the computing device. Upon optimization, the layout of the data structures is transformed such that an intended output of the application remains unaffected. The structure layout optimization may employ various heuristic techniques, such as hotness analysis and affinity analysis, to enhance memory utilization.

Hotness analysis involves separation of frequently accessed fields of an application from rarely accessed ones. Based on the hotness analysis, the frequently accessed fields, termed as hot fields, are placed together in the memory. However, at runtime, all the hot fields may not be accessed together. Therefore, affinity analysis may be used to place the hot fields with strong affinity close to each other. For the purpose, the compiler transforms the layout of the data structures such that hot fields having strong affinity are placed in the same cache line to enhance spatial locality in the cache memory.

Such structure layout optimizations are often inter-procedural in nature, i.e., they apply the heuristic techniques across the whole application to make a layout decision. Therefore, every reference to a data structure selected for optimization undergoes the same layout transformation. However, a layout decision made based on the heuristic technique applied across the whole application may be sub-optimal to a certain region of the application. For example, a region of an application program may not access all hot fields of the data structure and therefore, the region may end up accessing the hot fields not intended to be accessed. In such a case, in that region, the processor fetches more than an intended volume of data, which in turn may degrade application performance.

Additionally, data access pattern of a data structure can be different for different regions. For example, a data structure, such as a tree may be traversed depth first or breadth first in different regions. Therefore, the inter-procedural structure layout techniques may become sub-optimal for a region of the application program. Further, if a layout decision for the whole program is made based on applying a heuristic technique to specific regions of the application, it would result in poor locality as well as cache utilization for other regions of the application.

Generally, structure layout optimizations are not implemented if it results in an alteration of the intended output of the application. To ensure that the optimization is safe, the compiler may implement various legality check criteria. Therefore, if the legality check criteria are not met for even a single region of the application program, the structure layout optimization may not be implemented and benefits available from the structure layout optimization may not be available.

In order to enhance the performance of the application program, embodiments of the present invention provide for a region based optimization (RBO) framework. The RBO framework identifies and optimizes delinquent regions of the application program. The delinquent regions may be the regions that did not benefit, partially or completely, from the structure layout optimization mentioned above or that were not optimized since the application program was not amenable to such structure layout optimization. In one implementation, the delinquent regions are identified based on a data utilization parameter. The data utilization parameter is computed based on a data volume that a region of the application program intends to access and a data volume that is actually accessed by the region to fetch the intended volume of data.

Additionally or alternatively, subsequent to identification of the delinquent regions, one or more candidate delinquent region(s) of the application may be selected for optimization based on a selection criteria. The candidate delinquent regions may be optimized by applying the RBO framework. In one implementation, the RBO framework creates an optimized structure type for the delinquent region such that cache utilization for the candidate delinquent region is enhanced. The optimized structure type may be instantiated by selectively copying data from a data structure that existed prior to implementation of the RBO framework. For the purposes of discussion, the data structure associated with the candidate delinquent region, which existed prior to the implementation of RBO framework, may be referred to as the original data structure.

The RBO framework may be performed on type safe languages, such as Java, as well as on non-type safe languages, such as C or C++. The RBO framework may also supplement other optimization techniques used in the compiler.

Devices that can implement the disclosed method(s) include, but are not limited to, desktop computers, hand-held devices, multiprocessor systems, microprocessor based programmable consumer electronics, laptops, network computers, minicomputers, mainframe computers, and the like.

While aspects of described systems and methods for optimizing a region of an application can be implemented in any number of different computing devices, environments, and/or configurations, the implementations are described in the context of the following exemplary device architecture(s).

### Exemplary Devices

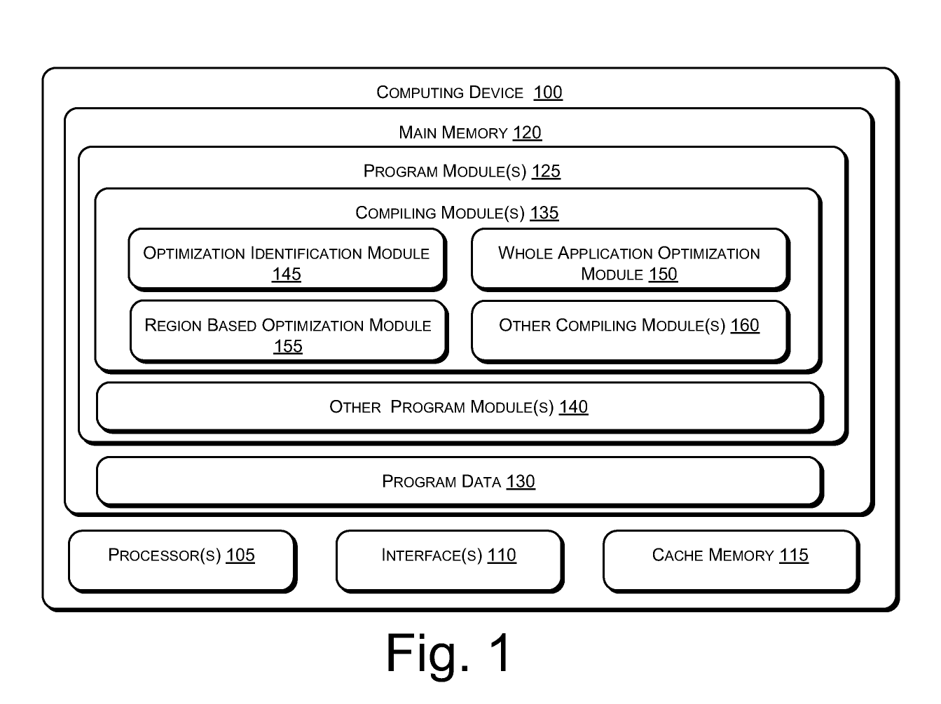

FIG. 1 illustrates an exemplary computing device 100 for optimizing an application program executed on the computing device 100, in accordance with an embodiment of the present invention. However, it will be understood that the application program may be compiled on the computing device 100 and, after compilation, may be executed on a different computing device. The application program may be interchangeably referred to as the application. The computing device 100 includes one or more processor(s) 105, interface(s) 110, and a memory, such as a cache memory 115 and a main memory 120.

The processor(s) 105 can be a single processing unit or a number of units, all of which could include multiple computing units. The processor 105 may be implemented as one or more microprocessors, microcomputers, microcontrollers, digital signal processors, central processing units, state machines, logic circuitries, and/or any devices that manipulate signals based on operational instructions. Among other capabilities, the processor 105 is configured to fetch and execute computer-readable instructions and data stored in the memory.

The interfaces 110 may include a variety of software and hardware interfaces, for example, interfaces for peripheral device(s), such as a keyboard, a mouse, an external memory, and a printer. Further, the interfaces 110 may enable the computing device 100 to communicate with other computing devices, such as web servers and external databases. The interfaces 110 can facilitate multiple communications within a wide variety of networks and protocol types, including wired networks, for example LAN, cable, etc., and wireless networks such as WLAN, cellular, or satellite. For the purpose, the interfaces 110 may include one or more ports for connecting a number of computing devices to each other or to another server computer.

In one implementation, the cache memory 115, also referred to as cache 115, acts like a temporary storage medium where frequently or recently accessed data can be stored for rapid access. In order to exploit spatial locality, the cache 115 may operate on several units of storage at a time and, therefore, may be divided into several cache lines or cache blocks. Generally, a minimum unit of data read from or written to a cache on a single fetch is called a cache line.

Once data is stored in the cache 115, it can be used in the future by accessing a cached copy of the data rather than re-fetching or re-computing the data from the main memory 120, thereby reducing execution time. In the present implementation, the cache 115, as illustrated, is placed separate from the processor(s) 105. However, the cache 115 may be placed along with the processor(s) 105 on the same integrated circuit. In addition, the cache includes any type of cache, such as L1 cache, L2 cache, and L3 cache.

The main memory 120 may include any computer-readable medium known in the art including, for example, volatile memory such as static random access memory (RAM) and dynamic RAMs, and/or non-volatile memory, such as read only memory (ROM), erasable programmable ROM, flash memories, hard disks, optical disks, and magnetic tapes.

The main memory 120 may also include program module(s) 125 and program data 130. The program module 125 includes routines, programs, objects, components, data structures, etc., which perform particular tasks or implement particular abstract data types. In one implementation, the program modules 125 include a compiling module 135 and other program modules 140. In another implementation, the compiling module 135 may be stored in an external storage media, which may be interfaced with the computing device 100 via the interface 110.

The compiling module 135 may translate a preliminary code, such as a source code of the application, to an optimized executable code. The compiling module 135 may include compilers, such as optimizing compilers, dynamic compilers, cascaders, transcompilers, or any combination thereof. In one implementation, the compiling module 135 may be an optimizing compiler. The compiling module 135 may optimize the application statically at compile time or may optimize the application dynamically at runtime of the application.

The compiling module 135 may include, for example, an optimization identification module 145, a whole application optimization (WAO) module 150, a region based optimization (RBO) module 155, and other compiling module(s) 160. In one implementation, the optimization identification module 145 activates the WAO module 150 or the RBO module 155 or both based on one or more legality check criteria. The legality check criteria may be employed to ensure the validity of a WAO framework implemented by the WAO module 150. The WAO framework may be applied to the whole application to optimize the layout of one or more data structures of the application. The WAO framework is called legal for the application if the legality check criteria are satisfied over the whole application.

Examples of legality check criteria include, but are not limited to, aliasing relationships, type-casting transformations, pointer arithmetic, library references, etc. In one example of legality check, the optimization identification module 145 may not activate the WAO module 150 when the application includes references to a non-standard library. Since, in such a scenario, the compiling module 135 would not be able to access variables and functions defined in such a non-standard library, the optimization of the whole application may not be performed in a safe manner. Therefore, even if a single region of the application refers to the non-standard library, the optimization identification module 145 may not activate the WAO module 150.

In another example, the optimization identification module 145 may not activate the WAO module if the application shows aliasing relationships, i.e. when more than one field refers to the same memory location, or involves pointer arithmetic. In such cases, any change made to the address of a pointer may result in an alteration in the intended output of the application. If, in such a scenario, the WAO framework is implemented, the compiling module 135 may need to identify all pointers that point to the transformed data structure. For the purpose, an accurate alias analysis may be required, which is often time consuming.

Such issues are often faced with weakly typed languages or non-type safe languages, such as C, C++, since in such languages there is often pervasive use of pointers and linked data structures or pointer-based data structures. Thus, the applications written in the non-type safe languages may not be optimized under the WAO framework or may require error-prone human inspection.

Specific legality check criteria used in the above examples may differ for various applications. Alternatively, some of the legality check criteria illustrated above as unsafe may be considered to be safe in some other implementations. Implementation of a legality check criterion may depend on the needs of an application. It will be appreciated that the legality check criteria discussed above are merely for illustration and not to limit the scope of the invention.

Thus, if the optimization identification module 145 determines that the WAO framework is legal, the optimization identification module 145 may activate the WAO module 150, else the RBO module 155 is activated. In one implementation, the WAO module 150 may be configured to optimize the application using a WAO framework. The WAO framework may include a variety of structure layout optimization techniques, such as structure splitting, field reordering, structure peeling, or dead field removal.

For example, the WAO module 150 may split the data structure under transformation into two different parts, namely a hot part and a cold part, using the methods known in the art. The hot part may contain fields of the application that are accessed frequently (hot fields), while the cold part may contain fields that are accessed rarely (cold fields). Further, the layout may be transformed such that the hot fields that are referenced together may be stored proximate to each other so that they are likely to be resident on the same cache line. Such a provision may provide for enhanced spatial locality of the cache 115 and better cache utilization, which in turn may result in enhanced application performance. The implementation of the WAO module 150, as described above, is for the purposes of illustration; however, any other structure layout optimization technique may also be used.

In one implementation, subsequent to the application of the WAO framework by the WAO module 150, the optimization identification module 145 activates the RBO module 155. In another implementation, the optimization identification module 145 may directly activate the RBO module 155 without activation of the WAO module 150. On activation, the RBO module 155 seeks to optimize those regions of the application that did not benefit from the WAO framework or which were not optimized since the application did not pass the legality check criteria implemented by the optimization identification module 145. Thus, the RBO framework and the WAO framework may supplement each other.

The RBO module 155 may consider the application to include a plurality of regions and may identify one or more delinquent regions of the application to apply the RBO framework. The granularity of a region to be considered for the RBO framework can vary from a coarse level to a fine level based on the preferences of a programmer of the compiling module 135 In one implementation, the granularity of the region can be an innermost loop level. In other implementations, the granularity of the region can be at a function level.

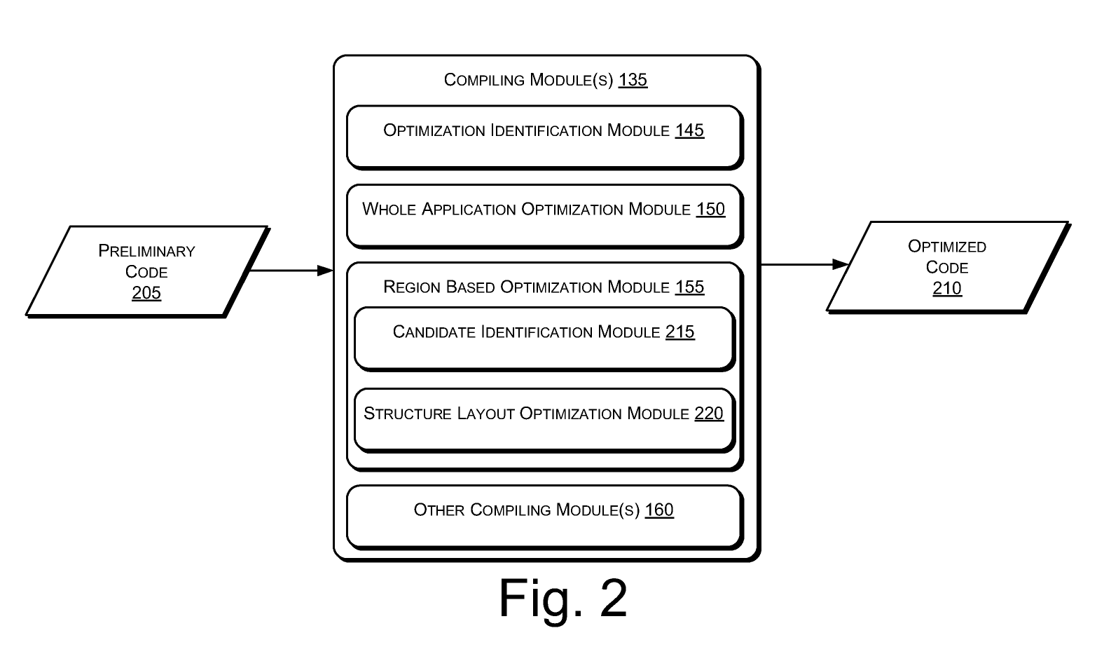

The identification of the delinquent regions may be based on a data utilization parameter, as will be explained in detail with reference to FIG. 2. In one implementation, subsequent to identification of a delinquent region, the RBO module 155 may optimize one or more identified delinquent regions by creating an optimized structure type so that cache utilization for the delinquent region is enhanced. For the purpose, the RBO module 155 may insert a code such as a create-code to create an optimized structure type based on delinquent region profile information. In one implementation, the optimized structure type may include a subset of fields that were identified as hot fields for the original data structure. In another implementation, the optimized structure type may contain a field, which was not placed in the hot part of the original data structure, since the field was a hot field for the delinquent region but not for the application.

Further, upon instantiation of the optimized structure type, an optimized data structure may be created by copying selective data from an original data structure associated with the delinquent region. Further, when the application is executed, data from the optimized data structure may be used instead of fetching the data from the original data structure, thereby enhancing the performance of the memory for the delinquent region.

Thus, the delinquent regions, which could not realize the full performance potential of the WAO framework or which were not optimized due to limitations of the WAO framework, may now be optimized locally, thereby enhancing the application performance. Although implementations of the present invention have been explained in considerable detail with reference to a cache memory; however it would be appreciated that the implementations may be extended to other memories known in the art.

The other compiling modules 160 can be configured to perform other compiling procedures, such as syntax analysis and semantic analysis. The other program modules 140 may include programs that supplement applications on the computing device 100, for example, programs in an operating system. The program data 130 includes data used by or generated as a result of the execution of one or more modules in the program modules 125.

FIG. 2 illustrates exemplary components of the compiling module 135, according to an embodiment of the present invention. In one implementation, the compiling module 135 receives a preliminary code 205 of the application and transforms the preliminary code 205 to an optimized code 210 of the application. The preliminary code 205 employs the original layout of the data structures of the application, while the optimized code 210 employs an optimized layout of the data structures of the application. The preliminary code 205 may be a source code, an intermediate representation of the source code, or an executable object code of the application. Therefore, it would be appreciated that the optimization may be performed at any stage by the compiling module 135. The application may be a pointer intensive application program; however, the application may be written in computer language as well.

As illustrated, the compiling module 135 includes the optimization identification module 145, the WAO module 150, the RBO module 155, and other compiling module 160. The optimization identification module 145 activates the WAO module 150 or RBO module 155 or both the modules 150 and 155 based on the legality check criteria applied to the entire preliminary code 205, as explained in the description with reference to FIG. 1.

In one implementation, the RBO module 155 includes, for example, a candidate identification module 215 and a structure layout optimization (SLO) module 220. The candidate identification module 215 is configured to identify one or more delinquent regions of the application for the RBO framework. The SLO module 220 may implement the RBO framework to optimize one or more identified delinquent regions, thereby optimizing the application. To optimize a delinquent region, the SLO module 220 may insert a code to create the optimized structure type having one or more data fields selected based on the delinquent region profile information. Further, the SLO module may also insert other codes to selectively copy data from the original data structure accessed by the delinquent region to the optimized data structure such that cache utilization for the identified delinquent region is enhanced.

As aforementioned, the identification of the delinquent regions of the application is based on a data utilization parameter. To quantify the data utilization parameter, a data volume may be defined as the total volume of data accessed over a region of the application. The data volume a programmer of the application intends to access over a given region, which may be through references to the data by the application, may be termed as programmer intended data volume (PIDV). Further, the data volume actually accessed during the execution of the region by the processor 105 may be termed as actually accessed data volume (AADV). In one implementation, the data utilization parameter may be a data utilization ratio, which is a ratio of PIDV to AADV. In another implementation, the data utilization parameter may be a data volume overhead, which is a difference of AADV and PIDV. The data utilization parameter may be computed for every region of the application. Further, the data utilization parameter may be compared with a threshold data utilization parameter and based on the comparison a region may be identified as the delinquent region.

For the purposes of illustration, the granularity of region may be of an inner loop level that traverses over a list or array of data structures. The PIDV accessed over a region L, which traverses over a list of structures of type T may be computed using the following equation:

PIDV(L,T)=N_{L}*(SF_{U}+ΣSF_{cf}*p_{f}) (1)

where N_{L}, is the number of loop iterations for region L, SF_{U} is the aggregated size of all unconditionally accessed fields in type T in each iteration by the application for that region, SF_{cf} is the size of a field f in type T that is conditionally accessed in a loop iteration, and p_{f} is probability of accessing the field f in an iteration.

Likewise, AADV over the region L in order to meet PIDV(L,T) for the region L may be computed using the following equation:

AADV(L,T)=N_{L}*C_{L}*CS (2)

where C_{L} is the number of cache lines that were brought in per iteration to meet PIDV(L,T) for L, and CS is the size of a cache line. The total programmer intended data volume for all types T in the region L, may be given by the below mentioned equation:

$$PIDV ( L ) = {\sum }_{T} ( PIDV ( L , T ) \qquad ( 3 )$$

Similarly, the total data volume actually brought in by the region L for all types T in the region L, assuming that similar data types are stored on the same cache line, may be given as:

$$AADV ( L ) = {\sum }_{T} ( AADV ( L , T , {SL}_{current} ( T ) ) ) \qquad ( 4 )$$

Thus, the data utilization ratio for the region L may be expressed as:

DU(L)=PIDV(L)/AADV(L) (5)

As it can be understood, AADV(L) would always be greater than or equal to PIDV(L). Closer the AADV(L) to PIDV(L) better the cache utilization of the region L under consideration. Hence, the higher the data utilization ratio, the better the performance of the application. Similarly, the data volume overhead for the region L may be expressed as:

DVoh(L)=AADV(L)−PIDV(L) (6)

In one example, if the data utilization ratio is close to “1”, then the data volume overhead is small and the region L can be said to be optimized. In order to identify the delinquent regions of the application, the candidate identification module 215 may define a threshold data utilization ratio. The regions with data utilization ratio less than the threshold data utilization ratio may be identified as the delinquent regions of the application.

In another example, in order to determine the delinquent regions of the application, the candidate identification module 215 may define a threshold data volume overhead. The regions with the data volume overhead greater than the threshold data volume overhead may be identified as the delinquent regions of the application.

The data volume overhead, as computed above, may affect execution time of the application, since there is a finite cost associated with each unit of data that is accessed by the application. The cost may be due to multiple factors, such as an actual cost of data access for each unit of data, the impact of the amount of data accessed on dcache misses, memory bandwidth, and DTLB misses.

Assuming an average fixed unit cost for each byte of data accessed, the Data Volume Overhead Cost (DVohc(L)) may be estimated using the following equation:

DVohc(L)=DVoh(L)*average cost for each unit of data accessed

Typically, it takes a several cycles for a processor to fetch a single cache line, the average cost of each unit of data accessed by a value of k cycles may be estimated as:

DVohc(L)=DVoh(L)*k (7)

where k may be approximated as the ratio of data fetch time to the cache line size. Generally, the DVohc is borne by the application and therefore impacts its execution time and degrades application performance

For example, consider a region L that iterates over a list of structure with each structure element size 64 bytes, where each element in the list is aligned to a cache line and occupies full cache line size. If one integer word field f is accessed in the region L, then the application actually ends up fetching 64 bytes for each reference to the field f, whereas the programmer may intend to use 4 bytes out of the 64 bytes accessed. Assuming an iteration count of 10000 from a profile data of the application, the PIDV(L) can be computed as 40000 and the AADV(L) as 640000 for the region L.

The data utilization ratio can be computed as 0.0625 and the data volume overhead as 600000. As explained before, the data utilization ratio or data volume overhead may be calculated for every region of the application. For example, if a threshold data utilization ratio is assumed to be 0.7, then based on a comparison of the data utilization ratio of the region L, the region L may be marked as a delinquent region. The aforementioned metrics for identification of the delinquent regions are for the sake illustration only. The metrics may be altered or modified according to the requirements of an application.

In another implementation, the candidate identification module 215, subsequent to identification of the delinquent regions, may select candidate delinquent regions that may be optimized safely and profitably based on one or more selection criteria, such as validity analysis and profitability analysis.

Validity analysis may include one or more validity criteria, which may be similar to the legality check criteria, the difference being that the validity analysis is applied over each of the delinquent regions instead of the whole application. Since the validity analysis is applied over a region of the application and not the entire application, the implementation of the RBO framework is wider than the WAO framework. This is because the RBO framework may be applied to one or more delinquent regions that pass the validity analysis even if the application as a whole did not pass the legality checks. Therefore, a probability of implementation of the RBO framework to type safe and type non-safe languages increases and accordingly, a probability of enhancing the application performance increases.

In a scenario, upon implementation of the validity analysis, if it is ascertained that the validity criteria are not satisfied over a delinquent region, the candidate identification module 215 may not consider such a delinquent region to be fit for RBO framework. However, if the candidate identification module 215 determines that the validity criteria are satisfied over the delinquent region, the candidate identification module 215 applies the profitability analysis to the delinquent regions.

In yet another implementation, for every delinquent region, the candidate identification module 215 identifies an outer region enclosing the delinquent region. In said implementation, the candidate identification module 215 applies the validity analysis on the delinquent region as well as on the corresponding outer region. Such a provision may further ensure validity and profitability of the RBO framework, when implemented on the delinquent region. Upon applying the validity analysis, if the candidate identification module 215 determines that it is safe to apply RBO framework over the delinquent region and the corresponding outer region, the candidate identification module 215 applies the profitability analysis. Although the metrics described for the profitability analysis are with respect to a delinquent region and a corresponding outer region, the metrics may be altered such that the metrics are applied alone on the delinquent region.

The profitability analysis may be computed to determine a tradeoff between net benefits realized and overheads incurred upon application of the RBO framework to the delinquent region under consideration. The overheads may be incurred owing to copying of data upon application of the RBO framework by the SLO module 220. As already mentioned, the RBO framework is implemented by the SLO module 220, which selectively copies data for the delinquent region under consideration to enhance cache utilization for the delinquent region.

Therefore, prior to the application of the RBO framework on the delinquent regions, the candidate identification module 215 computes the net benefits associated with the delinquent regions under consideration. Further, based on the net benefits computed, the candidate identification module 215 selects the delinquent regions that can be optimized profitably as candidate delinquent regions. In one implementation, the candidate delinquent regions are considered for optimization if the net benefits outweigh the overheads incurred due to optimization of the delinquent region.

For the purpose, the candidate identification module 215 first computes benefits obtainable upon implementation of the RBO framework over the original data structure of the application. In one implementation, to compute net benefits, reductions in the data volume overhead (Dvoh) due to implementation of the RBO framework over the original data structure of the application may be estimated.

Let L_{WAO} be the layout used for a type T in the delinquent region L if the WAO framework is possible, and let L_{current} be the layout of the type T in the delinquent region L prior to application of any structure layout optimization framework. Further, in case the WAO module 150 is not actuated, L_{WAO} may be equal to L_{current}. Similarly, let L_{RBO} represent layout of the type T in the delinquent region L upon application of the RBO framework.

The estimated reductions in the data volume overhead due to application of WAO framework over L_{current} may be expressed by the following equation:

DVoh(L_{current})−DVoh(L_{WAO}); and (8)

The estimated reductions in the data volume overhead due to application of RBO framework over L_{current} may be expressed as:

DVoh(L_{current})−DVoh(L_{RBO}) (9)

Therefore, benefits of the RBO framework over the WAO framework by value of k cycles can be expressed as:

Benefits(L_{RBO})=(DVoh(L_{WAO})−DVoh(L_{RBO}))*k (10)

Further, the Benefits(L_{RBO}) may be expressed in terms of data volume using equation (6) as:

Benefits(L_{RBO})=(AADV(L_{WAO})−AADV(L_{RBO}))*k (11)

The overheads incurred owing to copying of data and maintaining coherence between the original data structure and the optimized data structure are not accounted for in the Benefits(L_{RBO}) as computed above. The original data structure would correspond to the data structure used in L_{WAO}. As mentioned before, in case the WAO framework is not applied L_{WAO} would be the same as L_{current}. The optimized data structure would correspond to the optimized structure type, created by the RBO framework, for the delinquent region. The overheads incurred may be computed based on the costs involved.

A cost involved in setting up the optimized data structure may be termed as SetupCost and a cost involved in keeping the optimized data structure in sync with the original data structure may be termed as SyncCost. The overall copycost may be the sum of the Setupcost and the Synccost.

Since, to set up the optimized data structure, all the fields of the original data structure over which the delinquent region traverses are to brought in the cache 115 at least once, the SetupCost may be defined as AADV cost incurred over the delinquent region for the original data structure of the delinquent region as expressed by the following equation:

SetupCost=AADV(L_{WAO})*k (12)

The SetupCost may be taken as the upper bound for the SyncCost and accordingly CopyCost can be computed as below:

CopyCost=2*SetupCost*k (13)

In order to implement the RBO framework conservatively, the benefits realized upon implementation of the RBO framework may be estimated over the outer region using the following equation:

Benefits_{OR}(L_{RBO})=Benefits_{DR}(L_{RBO})*N_{OR} (14)

where N_{OR} is number of iterations of the outer region, and OR and DR refer to outer region and delinquent region respectively. Thus, net benefits of application of RBO framework over the outer region when accounting for CopyCost may be expressed as:

$$\begin{matrix}net {benefits}_{DR} ( {L}_{RBO} ) = {Benefits}_{OR} ( {L}_{RBO} ) - CopyCost \\ = ( {Benefits}_{DR} ( {L}_{RBO} ) * {N}_{OR} ) - CopyCost\end{matrix} \qquad ( 15 )$$

The net benefits may be expressed in terms of actually accessed data volume using equation (11) as:

net benefits_{DR}(L_{RBO})=((AADV(L_{WAO})*(N_{OR}2))−AADV(L_{RBO})*N_{OR})*k (16)

The RBO framework is applied when the overheads incurred owing to copying of data associated with the optimized structure type are offset by enhanced cache utilization of the optimized delinquent region or in other words, when the net benefits are greater than a threshold value. For example, the RBO framework may be applied when the net benefits are positive. Thus, the candidate identification module 215 may select the candidate delinquents regions based on validity of optimization and incurred net benefits.

It would be understood that the above mentioned selection criteria may be applied in any other order than the one described above. Additionally or alternatively, various selection criteria may be combined together. Further, one or more selection criteria may not be applied for selecting candidate delinquent regions or may be modified to meet the requirements of an application.

Once the candidate delinquent regions satisfying the selection criteria are selected, the SLO module 220 may insert create-codes to create one or more optimized structure types for each of the candidate delinquent regions. In one implementation, an optimized structure type for a candidate delinquent region is created using corresponding delinquent region profile information. The delinquent region profile information includes, for example, access frequency of fields in the delinquent region, regional affinity of the fields in the delinquent region, data access pattern of the original data structure in the delinquent region. The delinquent region profile information may be gathered from techniques, such as fields pair-wise affinity profile, fields access frequency profile, loop structure graph, field structure graph, etc., and tools such as bbcache. Thus, the optimized structure type contains selected fields, for example, hot fields of the candidate delinquent region, which may be arranged based on regional affinity of the fields and access patterns specific to the delinquent region under optimization.

The SLO module 220 may also insert various other codes, such as copy-code, sync-code, reference-code, and free-code, based on an implementation of the RBO framework. The codes may vary for different implementations of the RBO framework. The implementation of the RBO framework may be better understood with the following example. Consider an application accessing a data structure, say emp_rec, containing various fields for employees of a company. The fields may be, for instance, name, employee ID, date of birth, date of joining, address, telephone number, designation, blood group, leaves taken, and qualification.

Assuming an application where two functions, say sal_cal, and exp_cal, of the application access the empl_rec data structure. The function sal_cal calculates salary of the employees, while the function exp_cal calculates experience of the employees. Supposing that for calculating the salary, the sal_cal would need employee ID, leaves taken, and designation, while for calculating the experience, the exp_cal would need name, employee ID, and date of joining from the emp_rec data structure. Upon implementation of a WAO framework, the hot fields identified may be names, employee ID, date of joining, leaves taken, and designation. Therefore, the WAO framework would split the emp_rec into two parts: a hot part containing the hot fields: name, employee ID, leaves taken, date of joining, designation, and a reference field pointing to a cold part, and a cold part containing rest of the fields of the emp_rec data structure.

Further, it can be seen that even after splitting of the emp_rec data structure into the hot part and the cold part, the WAO framework may still be sub-optimal for either of the two functions exp_cal and sal_cal, since the two functions would still be accessing fields, which the two functions exp_cal and sal_cal did not intend to access. Therefore, the described RBO framework can be used to create an optimized structure type for either or both of the two functions, subject to the selection criteria discussed above.

Considering a case where the selection criteria are satisfied for the exp_cal function, an optimized structure type, say emp_rec1, is created such that cache utilization for the exp_cal function is enhanced. In one implementation, the optimized structure type emp_rec1 includes data selected using a delinquent region profile analysis. The emp_rec1 structure type may contain selective hot fields: name, employee ID, and date of joining. Further, the emp_rec1 structure type may follow a data access pattern for the function exp_cal. Additionally or alternatively, the fields in the hot part1 may be placed based on their regional affinity.

Upon instantiation of the emp_rec1 structure type, an emp_rec1 structure may be created in a memory, such as the main memory 120. Since the emp_rec1 structure type contains the hot fields of the exp_cal function and not the entire application, when the data from the emp_rec1 structure is brought in the cache 115, the cache utilization for the exp_cal function is enhanced. Enhanced cache utilization may in turn provide for reduction in application execution time, thereby enhancing application performance. It would be understood that the above example is for the purposes of illustration, and should not be construed as a limitation.

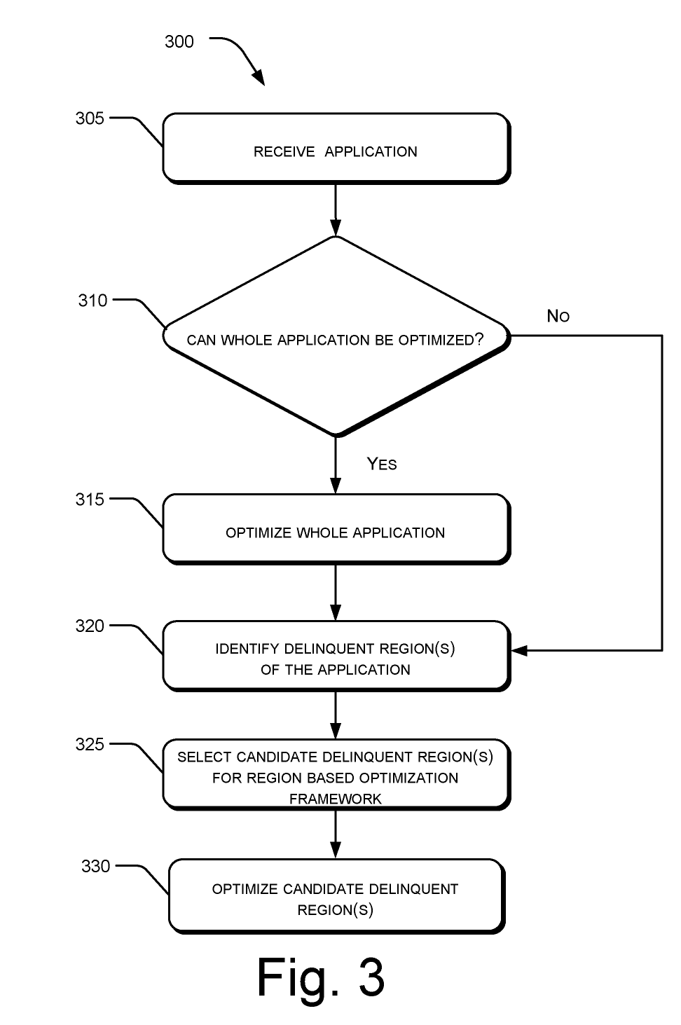

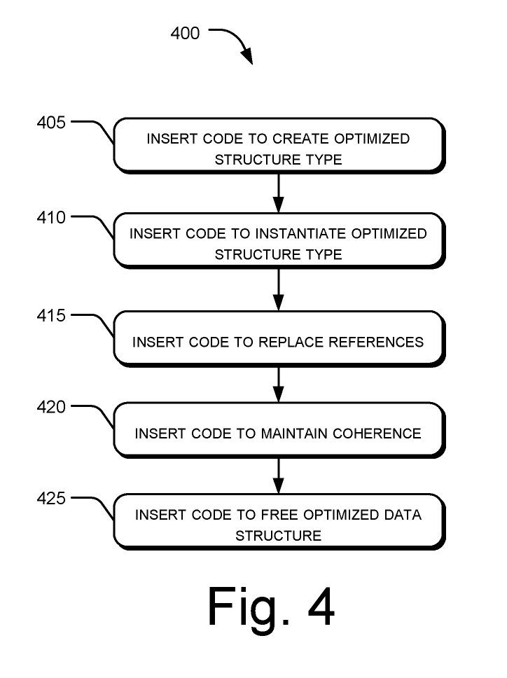

FIG. 3 and FIG. 4 illustrate an exemplary method for optimizing an application and an exemplary implementation of the RBO framework, in accordance with an embodiment of the present invention.

The exemplary methods may be described in the general context of computer executable instructions embodied on a computer-readable medium. Generally, computer executable instructions can include routines, programs, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

The order in which the methods are described is not intended to be construed as a limitation, and any number of the described method blocks can be combined in any order to implement the method, or an alternative method. Additionally, individual blocks may be deleted from the methods without departing from the spirit and scope of the subject matter described herein. Furthermore, the methods can be implemented in any suitable hardware, software, firmware, or combination thereof

Referring to FIG. 3, an exemplary method 300 optimizes an application by transforming layout of one or more data structures of an application using a compiling module, such as the compiling module 135.

At block 305, an application to be optimized is received. In one implementation, the compiling module of the computing device, receives the application. The application may be received in the form of a preliminary code 205, such as a source code, an intermediate code, a compiled code, or any code optimized prior to application of a structure layout optimization technique.

At block 310, it is determined whether the whole application can be safely optimized. The determination may be based on one or more of legality check criteria. In case, the legality check criteria are satisfied over the whole application, the block 310 branches to the block 315.

On the other hand, if the legality check criteria are not satisfied over the whole application, the application may not be optimized and the block 310 branches to the block 320. In one implementation, the determination may be made by an optimization identification module, such as the optimization identification module 145 of the compiling module 135.

At block 315, the application may be optimized using a WAO framework. The WAO framework includes various optimization techniques, such as structure splitting, field reordering, structure peeling, and dead field removal. In one implementation, a WAO module 150 of the compiling module implements the WAO framework for optimizing the layout of one or more data structures of the application.

At block 320, one or more delinquent regions of the application may be identified for a RBO framework. The regions which were either not optimized completely at block 315 or which were not optimized at all subsequent to the determination made at block 310 may be considered for identification of the delinquent regions.

In one implementation, the identification includes determination of the delinquent regions of the application based on a data utilization parameter. The data utilization parameter is associated with a data volume of a region of the application a programmer of the application intended to access (PIDV) and a data volume actually accessed (AADV) by the region to fetch PIDV. For example, the data utilization parameter can be a data utilization ratio. The data utilization ratio is a ratio of PIDV to AADV. The data utilization ratio may be computed for a plurality of regions of the application and the regions with the data utilization ratio less than a threshold data utilization ratio may be marked as the delinquent region. In another example, the data utilization parameter can be a data volume overhead. The data volume overhead is a difference of PIDV and AADV. Regions of the application with a data volume overhead greater than a threshold a data volume overhead may be identified as the delinquent region.

At block 325, subsequent to identification of the delinquent regions, one or more candidate delinquent regions are selected for the RBO framework based on one or more selection criteria. The selection criteria can include validity analysis and profitability analysis. In one implementation, the selection of the candidate delinquent regions may also include identifying outer regions enclosing the delinquent regions. In said implementation, the selection criteria is applied over each delinquent region and the corresponding outer region. Further, based on the selection criteria being satisfied over a delinquent region and the corresponding outer region, the delinquent region is selected as a candidate delinquent region for the RBO framework. For instance, a RBO module, such as the RBO module 155, of the compiling module 135 identifies the candidate delinquent regions of the application for implementing the RBO framework.

At block 330, the candidate delinquent regions selected at block 325 are optimized using the RBO framework. The candidate delinquent regions are optimized such that the cache utilization for these regions is enhanced, which in turn may provide for better execution time and reduction in dcache misses and DTLB misses.

Referring to FIG. 4, an exemplary method 400 illustrates an exemplary code transformation implemented by a RBO framework. The RBO framework seeks to optimize one or more delinquent regions of an application to enhance application performance. A RBO module, such as the RBO module 155, may implement the RBO framework. The described code transformations by the RBO framework may be implemented on one or more delinquent regions of the application. For every candidate delinquent region identified for the RBO framework, a corresponding optimized structure type may be created based on delinquent region profile information specific to that candidate delinquent region. Thus, the candidate delinquent regions are optimized locally without effecting the overall structure layout of the whole application. Further, various codes may be inserted statically at compile time or dynamically at run time.

At block 405, a create-code is inserted to create an optimized structure type for a candidate delinquent region such that cache utilization for the candidate delinquent region is enhanced. The create-code creates the optimized structure type so that the optimized structure type includes selected data fields, such as the hot fields of the candidate delinquent region. For the purpose, the create-code may use delinquent region profile information, which includes access frequency of fields, regional affinity of the fields, and data access pattern associated with the delinquent region. Thus, the optimized structure type has a layout that may follow the data access pattern of the candidate delinquent region and may include the hot fields specific to the candidate delinquent region.

At block 410, a copy-code may be inserted to instantiate an optimized data structure of the optimized structure type in a memory, such as the main memory 120. The optimized data structure may be instantiated at an entry point of a corresponding outer region of the candidate delinquent region. The instantiation may be made independent of the execution of the outer region as well.

Since the optimized data structure is an instantiation of the optimized structure type, the optimized data structure includes data based on the delinquent region profile information. The optimized data structure can be created by selectively copying data from an original data structure of the candidate delinquent region to the optimized data structure during execution of the candidate delinquent region. Further, memory may be allocated dynamically using a memory allocation function, such as malloc. Alternatively, memory allocation may take place statically at compile time.

At block 415, a reference-code may be inserted in the candidate delinquent region to replace the references made to the original data structure by references to the optimized data structure.

At block 420, a sync-code may be inserted in the candidate delinquent region to maintain coherence between the original data structure and the optimized data structure. The sync-code may add updates to the optimized data structure at points of updates to the original data structure and vice-versa. Additionally or alternatively, the sync-code may include instructions for selectively updating the original data structure when the optimized data structure is updated and vice versa. For example, when a field of the candidate delinquent region is not used by the application after the execution of the candidate delinquent region, the RBO framework may choose not to update the field in the original data structure.

Further, the sync-code may be configured to delay the synchronization between the original data structure and the optimized data structure until the point of use of the original data structure, also known as lazy sync-up. In addition, the sync-code may reduce the copying overhead by chunking the synchronization instead of point updates.

At block 425, a free-code is inserted to free the optimized data structure upon completion of execution of the candidate delinquent region. Alternatively, the free-code may be inserted to free the optimized data structure upon execution of the outer region. Further, the free-code may be inserted if memory is allocated dynamically.

The method 400 illustrates an exemplary implementation of the RBO framework and is not intended to be construed as a limitation of the present invention. Additionally or alternatively various codes may be inserted or deleted or the codes may be combined together to form a single code in various implementation of the RBO framework. A person skilled in the art may implement the RBO framework in many alternate ways.

### CONCLUSION

Although implementations of a region based optimization framework in computing devices have been described in language specific to structural features and/or methods, it is to be understood that the invention is not necessarily limited to the specific features or methods described. Rather, the specific features and methods are disclosed as exemplary implementations for the region based optimization framework.

I/We claim:

1. A method comprising:
identifying a delinquent region of an application program based at least on a data utilization parameter; and
optimizing the delinquent region by creating an optimized structure type associated with the delinquent region, wherein the optimized structure type includes at least one data field selected based on delinquent region profile information.

2. The method as claimed in claim 1, wherein the delinquent region profile information comprises access frequency of data fields in the delinquent region, regional affinity of the data fields in the delinquent region, and data access pattern associated with the delinquent region.

3. The method as claimed in claim 1, further comprising
inserting a copy-code to instantiate an optimized data structure of the optimized structure type;
inserting a reference-code to replace references to an original data structure by references to the optimized data structure; and
inserting a sync-code to maintain coherence between the original data structure and the optimized data structure.

4. The method as claimed in claim 1, further comprising selecting the delinquent region for optimization based on at least one selection criteria applied over the delinquent region.

5. The method as claimed in claim 4, wherein the selection criteria are applied over the delinquent region and an outer region enclosing the delinquent region.

6. The method as claimed in claim 1, further comprising computing the data utilization parameter based on an intended data volume of the delinquent region and an accessed data volume of the delinquent region.

7. A computer-readable medium having a set of computer readable instructions that, when executed, perform acts comprising:
selecting a candidate delinquent region for optimization based on at least one selection criteria; and
creating an optimized structure type associated with the candidate delinquent region, wherein the optimized structure type includes at least one data field selected based on at least one of access frequency of data fields in the candidate delinquent region, regional affinity of the data fields in the candidate delinquent region, and data access pattern associated with the candidate delinquent region.

8. The computer-readable medium as claimed in claim 7, wherein the selection criteria includes at least one of a validity analysis and a profitability analysis.

9. The computer-readable medium as claimed in claim 8, wherein the profitability analysis comprises:
estimating net benefits and overheads associated with the optimization; and
selecting the delinquent region for the optimization based on the net benefits and the overheads.

10. The computer-readable medium as claimed in claim 7, further comprising instructions for:
inserting a copy-code to create an optimized data structure upon instantiation of the optimized structure type, wherein the optimized data structure includes data copied selectively from an original data structure associated with the candidate delinquent region;
inserting a reference-code to replace references to the original data structure by references to the optimized data structure; and
inserting a sync-code to maintain coherence between the original data structure and the optimized data structure.

11. The computer-readable medium as claimed in claim 7, further comprising inserting a free-code to free an optimized data structure.

12. A computing device comprising:
a memory;
a processor operatively coupled to the memory; and
a region based optimization module comprising,
a candidate identification module configured to select at least one candidate delinquent region of an application program based at least on a selection criteria; and
a structure layout optimization module configured to optimize the candidate delinquent region based on delinquent region profile information.

13. The computing device as claimed in claim 12, wherein the structure layout optimization module is configured to optimize the candidate delinquent region by inserting a create-code to create an optimized structure type based on the delinquent region profile information.

14. The computing device as claimed in claim 12, further comprising:
a whole application optimization module configured to optimize the application program using a whole application optimization framework; and
an optimization identification module to activate at least one of the whole application optimization module and the region based optimization module based on at least one legality check criteria.

15. The computing device as claimed in claim 12, wherein the structure layout optimization module is configured to:
insert a copy-code to instantiate an optimized data structure of the optimized structure type;
insert a reference-code to replace references to an original data structure by references to the optimized data structure; and
insert a sync-code to maintain coherence between the original data structure and the optimized data structure.
